(19) United States
(12) Patent Application Publication
(10) Pub. No.: US 2008/0226283 A1
(43) Pub. Date: Sep. 18, 2008

(54) Four-axis camera mount for medical purpose

(76) Inventors: Kuo-Bi Yu, Taipei (TW); Zhi-Wei Lin, Tapei (TW); Hung-Ming Chen, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/723,384

(22) Filed: Mar. 19, 2007

(30) Foreign Application Priority Data
Mar. 12, 2007 (TW) 96204019

(51) Int. Cl. F16M 13/00

(52) U.S. Cl. 396/428

(57) ABSTRACT

A four-axis camera mount for medical purpose includes a cantilever arm having different sections separately turnable in X, Y, and Z axis; a coupling element having a camera coupled therewith; a screw rod assembly having a screw rod connected at an inner end to a motor in a base located at a free end of the cantilever arm, and a moving element mounted around the screw rod and fastened to the coupling element, so that the screw rod can be driven by the motor to rotate for the moving element and the coupling element to linearly reciprocate; and a guiding mechanism mounted to the base and having a locking plate fastened to the moving element to ensure stable linear reciprocation of the moving element and the coupling element. Therefore, the camera on the coupling element may have an increased shooting area.

### FIELD OF THE INVENTION

The present invention relates to a four-axis camera mount for medical purpose, and more particularly, to a four-axis camera mount for medical purpose that allows a camera mounted thereto to be moved and adjusted to any positions best for shooting desired pictures.

### BACKGROUND OF THE INVENTION

A conventional four-axis camera mount for medical purpose includes a coupling element and a cantilever arm. The coupling element is configured to lock a camera thereto. The cantilever arm is connected to the coupling element, and includes three mechanical joints, which may be independently turned about X, Y, and Z axis, so that the coupling element may be moved in all directions to adjust the camera locked thereto to an angular position best for shooting a desired picture.

When the camera has been adjusted to the best angular position for shooting, it is possible the area covered by the camera is not exactly what a doctor wants. At this point, the conventional four-axis camera mount for medical purpose does not allow further adjustment of the camera in position. On the other hand, while it is possible to turn the mechanical joints to adjust the shooting area, the shooting angle is not changed, preventing the camera from shooting at the best angular position. It is therefore desirable to improve the conventional four-axis camera mount for medical purpose, so that the camera mounted thereto can be freely adjusted to any angular position and cover any desired area for shooting.

### SUMMARY OF THE INVENTION

A primary object of the present invention is to provide a four-axis camera mount for medical purpose that allows a camera mounted thereto to be moved and adjusted to any positions best for shooting desired pictures.

To achieve the above and other objects, the four-axis camera mount for medical purpose according to the present invention includes a cantilever arm; a screw rod assembly connected to and accordingly driven by a motor to rotate; a guiding mechanism mounted on the cantilever arm at a predetermined position and coupled with the screw rod assembly; and a coupling element connected to the screw rod assembly and configured for a camera to couple therewith.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a four-axis camera mount for medical purpose according to a preferred embodiment of the present invention;

FIG. 2 is a perspective view of a first embodiment of a guiding mechanism included in the present invention;

FIG. 3 is a sectional view of a screw rod assembly included in the present invention;

FIG. 4 is a cross sectional view of the guiding mechanism of FIG. 2;

FIG. 5 shows the location of motors included in the four-axis camera mount of the present invention;

FIG. 6 shows the movement of a first section of a cantilever arm included in the present invention;

FIG. 7 shows the movement of a second section of the cantilever arm included in the present invention;

FIG. 8 shows the movement of a third section of the cantilever arm included in the present invention;

FIG. 9 is a perspective view showing a second embodiment of the guiding mechanism mounted on the present invention;

FIG. 10 is a perspective view of the second embodiment of the guiding mechanism of FIG. 9; and

FIG. 11 is a perspective view showing the present invention with a camera mounted to another different side of the guiding mechanism of the present invention.

### DETAILED DESCRIPTION OF THE PREFERRED EMBODIMENTS

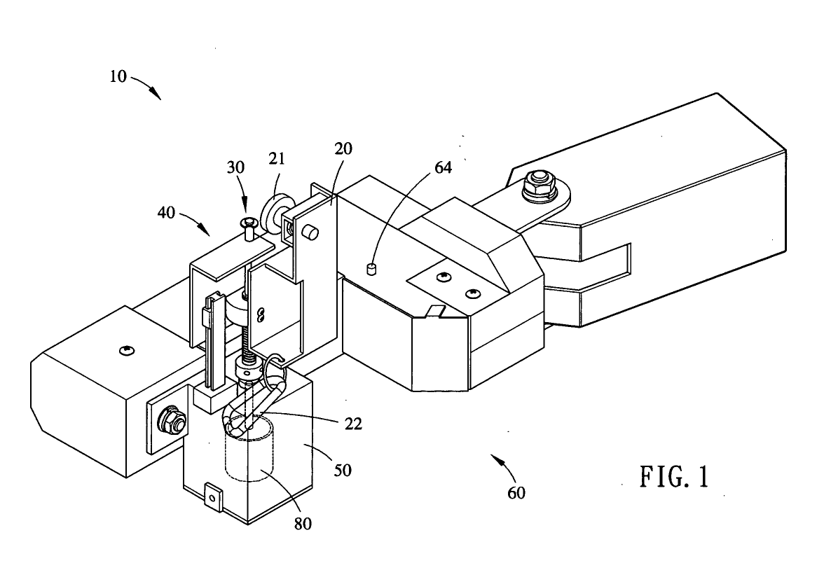

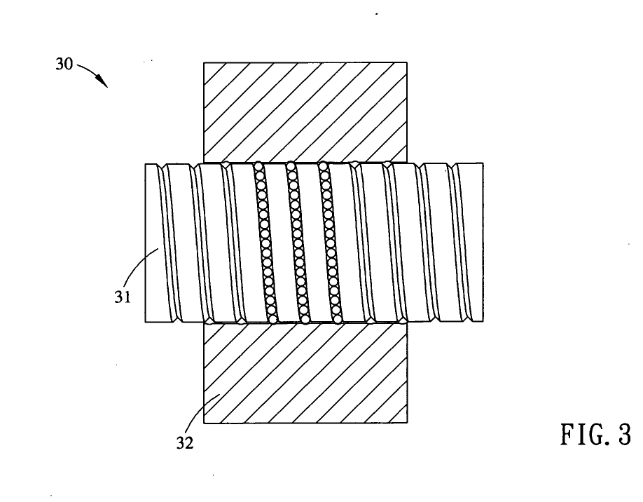

Please refer to FIGS. 1, 2, 3, and 4 at the same time. A four-axis camera mount for medical purpose 10 according to a preferred embodiment of the present invention includes a coupling element 20, a screw rod assembly 30, a guiding mechanism 40, a base 50, and a cantilever arm 60.

A camera (not shown) may be fixedly connected to the coupling element 20 with a screw element 21, which is extended through a screw hole provided on the coupling element 20. A loop 22 is provided on the coupling element 20 for protectively binding the camera to the coupling element 20, lest the camera should fall when the screw element 21 is unexpectedly loosened from the camera. That is, the loop 22 serves as a secondary safety guard for the camera mounted on the coupling element 20. The coupling element 20 is fixedly fastened to the screw rod assembly 30, so as to be moved and adjusted to different positions through operation of the screw rod assembly 30.

The base 50 is a hollow case having a substantially rectangular configuration, and is mounted to a free end of the cantilever arm 60. The base 50 is internally provided with a first motor 80, which applies a driving power to the screw rod assembly 30. The cantilever arm 60 is provided at a predetermined position with a socket 64 for the purpose of electrical connection of the camera mount to a power source.

The screw rod assembly 30 includes a screw rod 31 and a moving element 32 mounted around and movable along the screw rod 31. The coupling element 20 is fixedly fastened to the moving element 32. The screw rod 31 is connected at an inner end to the first motor 80. When the first motor 80 drives the screw rod 31 to rotate, threads on the screw rod 31 bring the moving element 32 and the coupling element 20 fastened thereto to reciprocate along the screw rod 31. Since it is connected to the coupling element 20, the camera is also brought by the rotating screw rod 31 to reciprocate. In the present invention, the screw rod assembly 30 maybe a ball screw rod assembly.

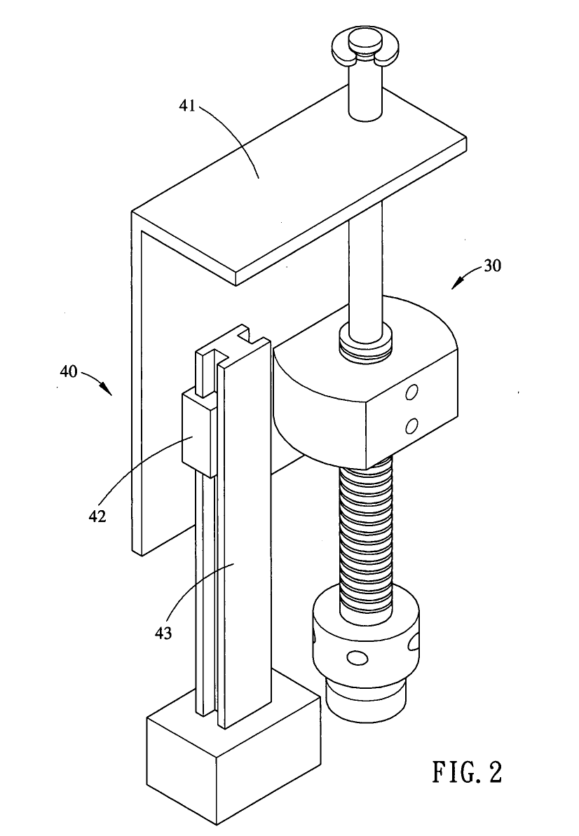

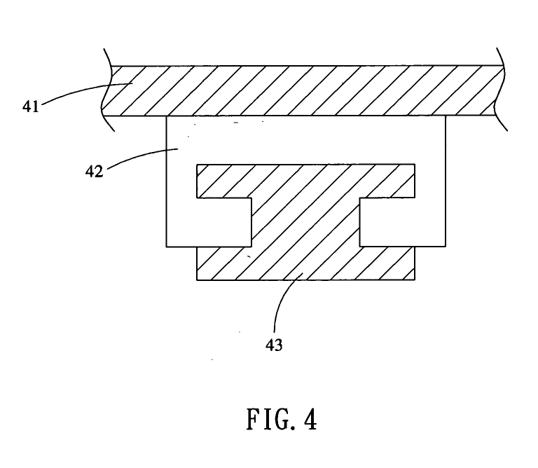

The guiding mechanism 40 is provided to guide and ensure the camera to stably move in a consistent direction. FIGS. 2 and 4 are a perspective and a cross sectional view, respectively, of a first embodiment of the guiding mechanism 40 in the form of a sliding rail assembly for guiding a linear reciprocating movement. In the first embodiment, the guiding mechanism 40 includes a locking plate 41, a slide 42, and a rail 43. The locking plate 41 is an L-shaped plate having a first portion and a second portion, which are perpendicular to each other. The rail 43 is fixedly connected at an inner end to the base 50, and has an I-shaped cross section. The slide 42 is slidably associated with the rail 43 and fixedly fastened to the second portion of the locking plate 41, such that when the locking plate 41 is moved, it brings the slide 42 to move at the same time. The screw rod 31 has an outer end extended through the first portion of the locking plate 41 and the moving element 32 is fixedly fastened to the second portion of the locking plate 41. Thus, when the screw rod 31 is driven by the first motor 80 to rotate, the moving element 32 moves along the screw rod 31 and brings the coupling element 20 and the locking plate 41 to move at the same time. When the locking plate 41 is moved by the moving element 32, the slide 42 fixedly fastened to the second portion of the locking plate 41 is brought to slide along the rail 43, helping the coupling element 20 and the camera mounted thereto to move stably.

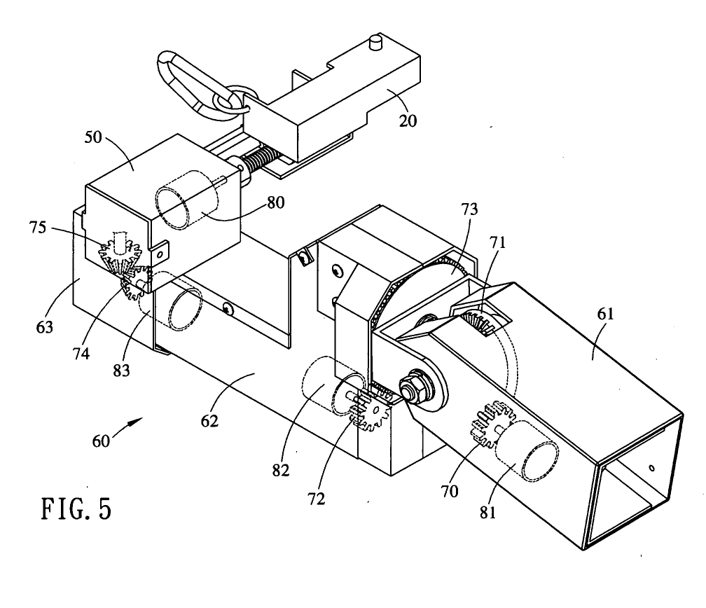

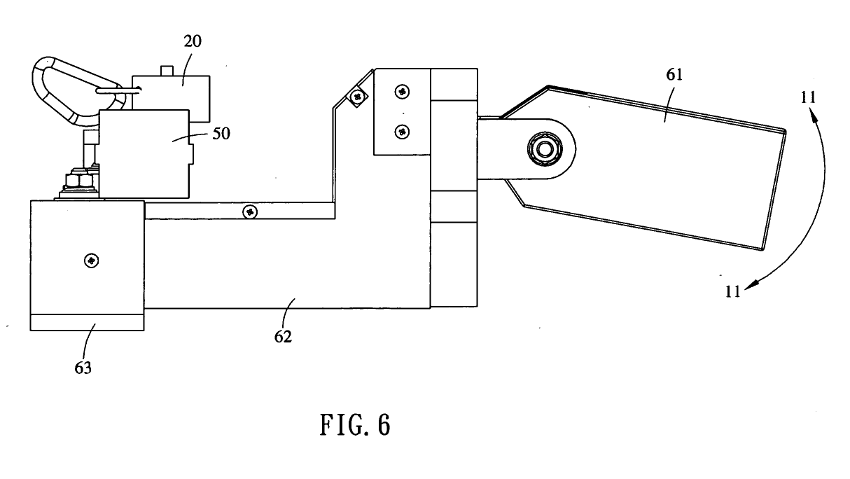

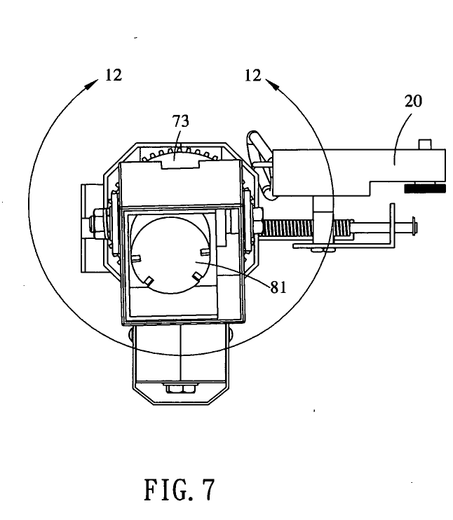

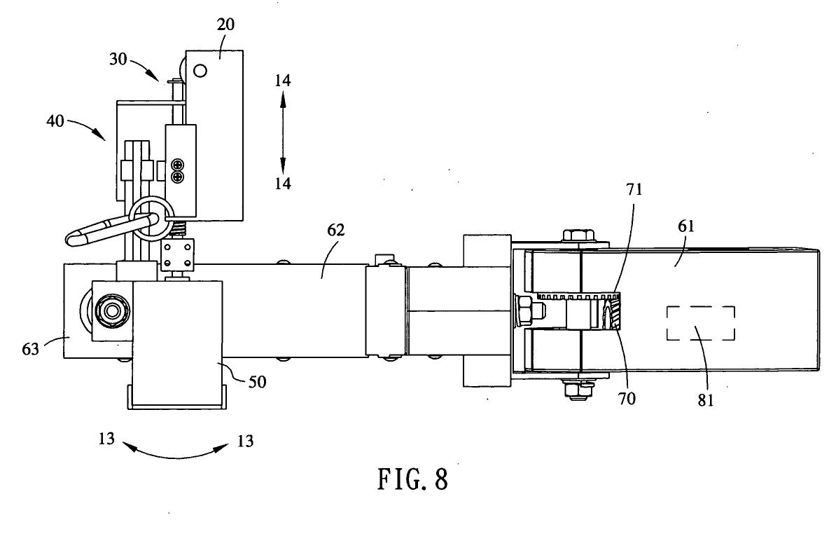

As can be seen from FIGS. 5 through 8, the cantilever arm 60 is driven by a second, a third, and a fourth motor 81, 82, 83, driving gears 70, 72, 74, and driven gears 71, 73, 75 to achieve movements in different directions. The cantilever arm 60 is associated with and thereby controls the coupling element 20 and accordingly, the camera to turn along with the cantilever arm 60, so that the camera can be moved to a desired position for shooting. The cantilever arm 60 consists of a first section 61, a second section 62, and a third section 63. The first section 61 may be pivotally turned about Y-axis within 180 degrees as indicated by the two-headed arrow 11 in FIG. 6 when the second motor 81 drives the gear set 70, 71 to rotate. The second section 62 of the cantilever arm 60 may be turned about X-axis when the third motor 82 drives the driving gear 72 to turn and the driving gear 72 further turns the driven gear 73 meshed therewith. Since the first section 61 is connected at an end to a gear face of the driven gear 73, the second section 62 is turned relative to the first section 61 within 360 degrees in a direction indicated by the two-headed arrow 12 in FIG. 7. The fourth motor 83 drives the driving gear 74 to turn, and the driving gear 74 further drives the driven gear 75 meshed therewith to turn about Z-axis. Since the driven gear 75 has a shaft connected to the base 50, the base 50 is caused to pivotally turn along with the driven gear 75 within 90 degrees relative to the third section 63 of the cantilever arm 60 as indicated by the two-headed arrow 13 in FIG. 8. With the cantilever arm 60 actuated to selectively turn about X, Y, and Z axes, the coupling element 20 is able to direct the camera to all directions. That is, the camera can be adjusted to any angular position best for shooting a desired picture.

The socket 64 is located at the second section 62 of the cantilever arm 60. When a power supply is input via the socket 64, the motors 80, 81, 82, and 83 are powered to drive the cantilever arm 60 to operate.

Please refer to FIGS. 1, 2, and 8 at the same time. When the first motor 80 applies a driving force to the screw rod assembly 30, the screw rod assembly 30 brings the coupling element 20 and the guiding mechanism 40 to move synchronously. Since the slide 42 is linearly reciprocated along the rail 43 in a direction indicated by the two-headed arrow 14 in FIG. 8, the moving element 32 of the screw rod assembly 30 is brought to linearly reciprocate in the same direction indicated by the two-headed arrow 14. As a result, the screw rod assembly 30 brings the coupling element 20 to linearly reciprocate in the direction indicated by the arrow 14, and the camera mounted on the coupling element 20 may be adjusted in position to obtain an increased shooting area.

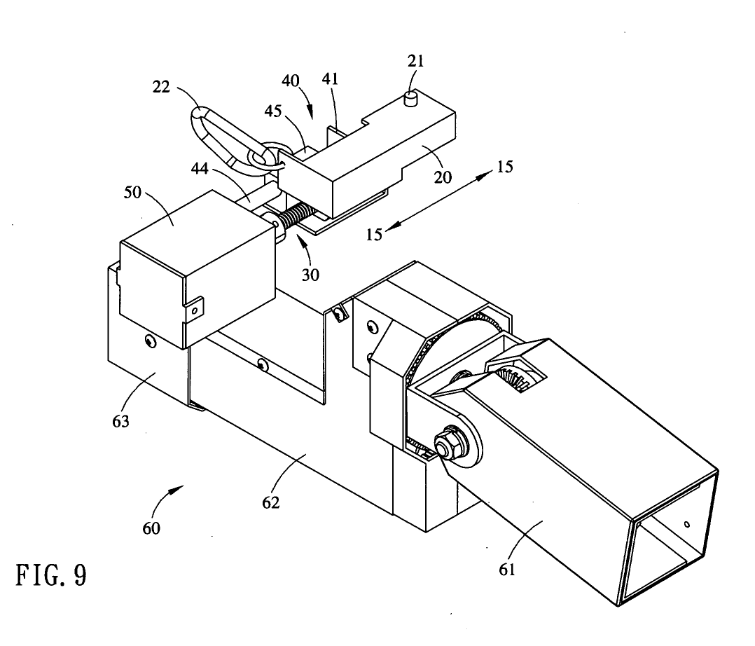

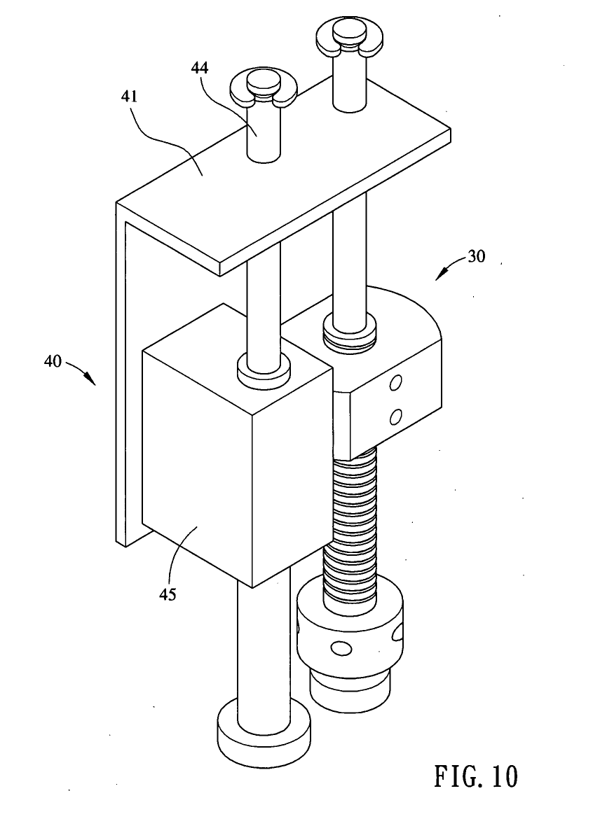

FIGS. 9 and 10 show a second embodiment of the guiding mechanism 40 in the form of a guide rod assembly to enable a linearly reciprocating movement. In the second embodiment, the guiding mechanism 40 includes a locking plate 41, a guide rod 44, and a bearing block 45. The guide rod 44 is fixedly connected at an inner end to the base 50. The bearing block 45 is movably mounted around the guide rod 44, so as to linearly reciprocate along the guide rod 44. The locking plate 41 is fixedly fastened to the bearing block 45 to move along with the bearing block 45. The locking plate 41 is also fixedly fastened to the moving element 32 of the screw rod assembly 30, and as having been mentioned above, the moving element 32 is also fixedly fastened to the coupling element 20. When the first motor 80 drives the screw rod 31 of the screw rod assembly 30 to rotate, the moving element 32 brings the coupling element 20 and the locking plate 41 to move linearly at the same time. Since the bearing block 45 fixedly fastened to the locking plate 41 is movably mounted around the guide rod 44, the bearing block 45 is able to linearly reciprocate along the guide rod 44 in a direction indicated by the two-headed arrow 15 in FIG. 9. As a result, the screw rod assembly 30 brings the coupling element 20 to reciprocate linearly in a direction indicated by the two-headed arrow 15, allowing the camera on the coupling element 20 to be adjusted in position to obtain an increased shooting area.

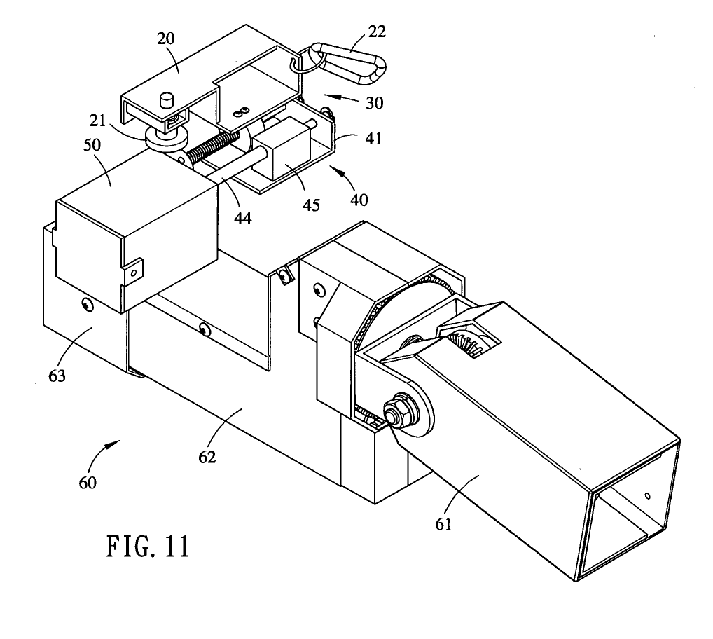

In the illustrated preferred embodiment of the present invention as shown in FIG. 1, the coupling element 20 and the screw rod assembly 30 are located at one side of the guiding mechanism closer to the cantilever arm 60. However, the coupling element 20 and the screw rod assembly 30 may be otherwise located at the other side of the guiding mechanism 40 farther to the cantilever arm 60, as shown in FIG. 11. That is, in the present invention, the screw rod assembly 30 and the coupling element 20 may together be located at any one of two sides of the guiding mechanism 40 to change the camera position to any one of two sides of the base 50.

With the above arrangements, the present invention provides a camera mount that allows the camera mounted thereto to move and change in position in four axes to increase the areas that can be shot with the camera, and is therefore particularly suitable for medical purpose.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A four-axis camera mount for medical purpose, comprising:
a cantilever arm;
a screw rod assembly connected to and accordingly, driven by a first motor to rotate;
a guiding mechanism mounted on the cantilever arm at a predetermined position and fastened to the screw rod assembly; and
a coupling element fastened to the screw rod assembly and configured for a camera to couple therewith.

2. The four-axis camera mount for medical purpose as claimed in claim 1, wherein the cantilever arm includes a base, in which the first motor is mounted for driving the screw rod assembly to rotate.

3. The four-axis camera mount for medical purpose as claimed in claim 2, wherein the guiding mechanism is fixedly mounted on the base of the cantilever arm.

4. The four-axis camera mount for medical purpose as claimed in claim 1, wherein the cantilever arm is a four-axis cantilever arm.

5. The four-axis camera mount for medical purpose as claimed in claim 2, wherein the guiding mechanism includes a locking plate, a slide, and a rail; the rail being fixedly connected at an inner end to the base, and the slide being slidably associated with the rail; and the locking plate being an L-shaped plate having a first portion, through which an outer end of the screw rod assembly is extended, and a second portion perpendicular to the first portion, to which the slide is fixedly fastened.

6. The four-axis camera mount for medical purpose as claimed in claim 2, wherein the guiding mechanism includes a locking plate, a guide rod, and a bearing block; the guide rod being fixedly connected at an inner end to the base, and the bearing block being movably mounted around the guide rod to linearly reciprocate along the guide rod; and the locking plate being an L-shaped plate having a first portion, through which an outer end of the screw rod assembly is extended, and a second portion perpendicular to the first portion, to which the bearing block is fixedly fastened.

7. The four-axis camera mount for medical purpose as claimed in claim 5, wherein the screw rod assembly includes a screw rod and a moving element movably mounted around the screw rod, and the moving element being fastened to the coupling element.

8. The four-axis camera mount for medical purpose as claimed in claim 6, wherein the screw rod assembly includes a screw rod and a moving element movably mounted around the screw rod, and the moving element being fastened to the coupling element.

9. The four-axis camera mount for medical purpose as claimed in claim 7, wherein the second portion of the locking plate is fastened to the slide and the moving element.

10. The four-axis camera mount for medical purpose as claimed in claim 8, wherein the second portion of the locking plate is fastened to the bearing block and the moving element.

11. The four-axis camera mount for medical purpose as claimed in claim 2, wherein the cantilever arm consists of a first section, a second section, and a third section, and the base is connected to the third section; the first section internally including a second motor for driving a first set of two meshed driving and driven gears to rotate, so that the first section is turnable about Y-axis; the second section internally including a third motor for driving a second set of two meshed driving and driven gears to rotate, so that the second section is turnable about X-axis relative to the first section; and the third section internally including a fourth motor for driving a third set of two meshed driving and driven gears to rotate, and the base being connected to a shaft of the driven gear in the third section, so that the base connected to the third section is turnable about Z-axis relative to the third section.
